(19) United States
(12) Patent Application Publication
(10) Pub. No.: US 2013/0205007 A1
(43) Pub. Date: Aug. 8, 2013

(54) SUGGESTING MIGRATION TO A CLOUD COMPUTING INFRASTRUCTURE

(71) Applicants: Naga A. Ayachitula, Elmsford, NY (US); Winnie Wing-Yee Cheng, Tarrytown, NY (US); James R. Moulic, Poughkeepsie, NY (US); Rajeev Puri, Huntersville, NC (US); Sambit Sahu, Hopewell Junction, NY (US)

(72) Inventors: Naga A. Ayachitula, Elmsford, NY (US); Winnie Wing-Yee Cheng, Tarrytown, NY (US); James R. Moulic, Poughkeepsie, NY (US); Rajeev Puri, Huntersville, NC (US); Sambit Sahu, Hopewell Junction, NY (US)

(73) Assignee: International Business Machines Corporation, Armonk, NY (US)

(21) Appl. No.: 13/368,491

(22) Filed: Feb. 8, 2012

(51) Int. Cl. G06F 15/173

(52) U.S. Cl. 709/224

(57) ABSTRACT

Embodiments of the present invention relate to an approach for suggesting/recommending migration of an IT environment to a cloud computing infrastructure. Specifically, in a typical embodiment, historical incident data of an information technology (IT) environment is analyzed. Based on the historical incident data, it may be determined whether a problem is recurring in the IT environment. If so, it may then be determined whether the problem can be mitigated in the cloud computing infrastructure. For example, it may be determined whether the cost of mitigating the problem by migrating to the cloud computing infrastructure is less than the cost of loss due to the problem within the current IT environment. A report particular to the IT environment that identifies a benefit of migrating the IT environment to the cloud computing infrastructure may be generated.

### TECHNICAL FIELD

In general, embodiments of the present invention relate to information technology (IT) environment migration. Specifically, embodiments of the present invention relate to the analysis of an existing IT environment to determine whether to suggest a migration to a cloud computing infrastructure.

### BACKGROUND

The networked computing environment (e.g., cloud computing environment) is an enhancement to the predecessor grid environment, whereby multiple grids and other computation resources may be further enhanced by one or more additional abstraction layers (e.g., a cloud layer), thus making disparate devices appear to an end-consumer as a single pool of seamless resources. These resources may include such things as physical or logical computing engines, servers and devices, device memory, and storage devices, among others.

As new technology and IT solutions continue to emerge, organizations may seek to migrate from existing infrastructure to newer environments. Challenges may, exist, however, in determining whether such a migration/change is prudent and/or cost effective. Factors such as costs, network down time, etc., can play a vital role in making IT migration decisions.

### SUMMARY

In general, embodiments of the present invention relate to an approach for suggesting/recommending migration of an IT environment to a cloud computing infrastructure. Specifically, in a typical embodiment, historical incident data of an information technology (IT) environment is analyzed. Based on the historical incident data, it may be determined whether a problem is recurring in the IT environment. If so, it may then be determined whether the problem can be mitigated in the cloud computing infrastructure. For example, it may be determined whether the cost of mitigating by migrating to the cloud computing infrastructure is less than the cost of loss due to the problem within the current IT environment. A report particular to the IT environment that identifies a benefit of migrating the IT environment to the cloud computing infrastructure may be generated.

A first aspect of the present invention provides a method for suggesting migration to a cloud computing infrastructure. The method includes at least one processor analyzing historical incident data of an information technology (IT) environment. The method further includes the at least one processor determining, based on the historical incident data, that a problem is recurring in the IT environment. The method further includes the at least one processor determining that the problem can be mitigated in the cloud computing infrastructure. The method further includes the at least one processor generating a report particular to the IT environment, the report identifying a benefit of migrating the IT environment to the cloud computing infrastructure.

A second aspect of the present invention provides a system for suggesting migration to a cloud computing infrastructure. The system includes a bus, a computer-readable storage device coupled to the bus, and a processor coupled to the bus. The system further includes program instructions, stored on the computer-readable storage device for execution by the processor, to analyze historical incident data of an information technology (IT) environment. The system further includes program instructions, stored on the computer-readable storage device for execution by the processor, to determine, based on the historical incident data, that a problem is recurring in the IT environment. The system further includes program instructions, stored on the computer-readable storage device for execution by the processor, to determine that the problem can be mitigated in the cloud computing infrastructure. The system further includes program instructions, stored on the computer-readable storage device for execution by the processor, to generate a report particular to the IT environment, the report identifying a benefit of migrating the IT environment to the cloud computing infrastructure.

A third aspect of the present invention provides a computer program product for suggesting migration to a cloud computing infrastructure. The computer program product includes a computer-readable storage device. The computer program product includes program instructions, stored on the computer-readable storage device, to analyze historical incident data of an information technology (IT) environment. The computer program product includes program instructions, stored on the computer-readable storage device, to determine, based on the historical incident data, that a problem is recurring in the IT environment. The computer program product includes program instructions, stored on the computer-readable storage device, to determine that the problem can be mitigated in the cloud computing infrastructure. The computer program product includes program instructions, stored on the computer-readable storage device, to generate a report particular to the IT environment, the report identifying a benefit of migrating the IT environment to the cloud computing infrastructure.

A fourth aspect of the present invention provides a method for deploying a system for suggesting migration to a cloud computing infrastructure. The method includes a computer system providing a computer infrastructure being operable to: analyze historical incident data of an information technology (IT) environment; determine, based on the historical incident data, that a problem is recurring in the IT environment; determine that the problem can be mitigated in the cloud computing infrastructure; and generate a report particular to the IT environment, the report identifying a benefit of migrating the IT environment to the cloud computing infrastructure.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 depicts a cloud computing node according to an embodiment of the present invention.

FIG. 2 depicts a cloud computing environment according to an embodiment of the present invention.

FIG. 3 depicts a set of functional abstraction layers provided by a cloud computing environment according to an embodiment of the present invention

FIG. 4 shows a component/process flow diagram according to an embodiment of the present invention.

FIG. 5 shows another component/process flow diagram according to an embodiment of the present invention.

FIG. 6 shows another component/process flow diagram according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which embodiments are shown. This disclosure may, however, be embodied in many different forms and should not be construed as limited to the embodiments set forth herein. Rather, these embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Embodiments of the present invention relate to an approach for suggesting/recommending migration of an IT environment to a cloud computing infrastructure. Specifically, in a typical embodiment, historical incident data of an information technology (IT) environment is analyzed. Based on the historical incident data, it may be determined whether a problem is recurring in the IT environment. If so, it may then be determined whether the problem can be mitigated in the cloud computing infrastructure. For example, it may be determined whether the cost of mitigating the problem is less than the cost of loss due to the problem within the current IT environment. Based on this determination, a report particular to the IT environment that identifies a benefit of migrating the IT environment to the cloud computing infrastructure may be generated.

### Cloud Computing Description

It is understood in advance that although this disclosure includes a detailed description of cloud computing, implementation of the teachings recited herein are not limited to being carried out by a cloud computing environment. Rather, embodiments of the present invention are capable of being implemented in conjunction with any other type of computing environment now known or later developed. Embodiments of the present invention focus on recommending/suggesting migration to a cloud computing environment from an alternate networked computing environment. Such an analysis could be performed by a cloud computing environment or other type of networked computing environment. As such, a detailed description of cloud computing is given in this section to provide a better understanding of the underlying teachings discussed herein.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed, automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly release to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited consumer-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

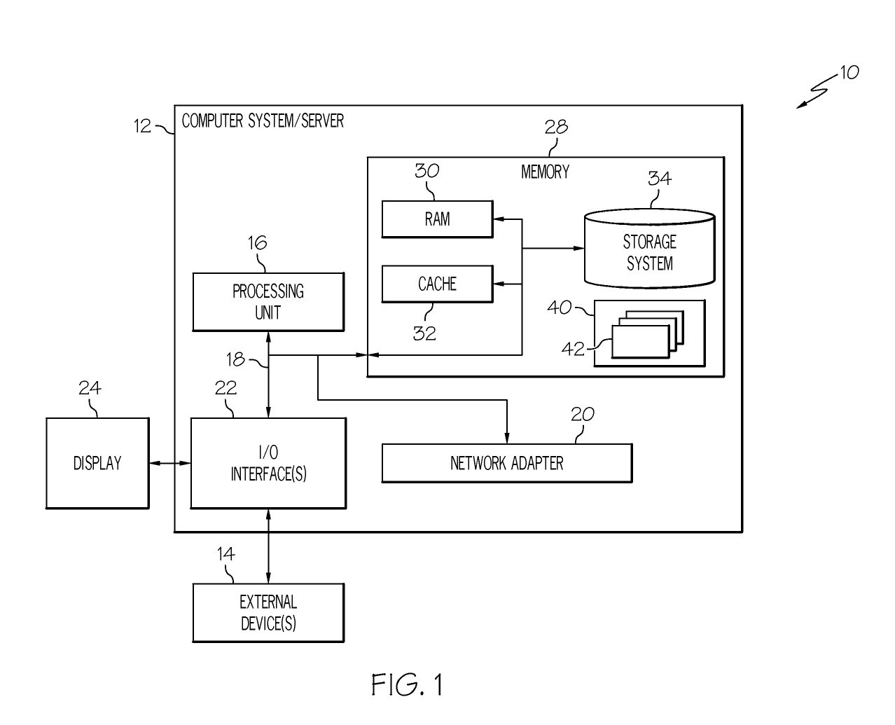

Referring now to FIG. 1, FIG. 1 depicts a cloud computing node according to an embodiment of the present invention. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media, on one or more of which program/utility 40 can be stored. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored wholly or partially in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

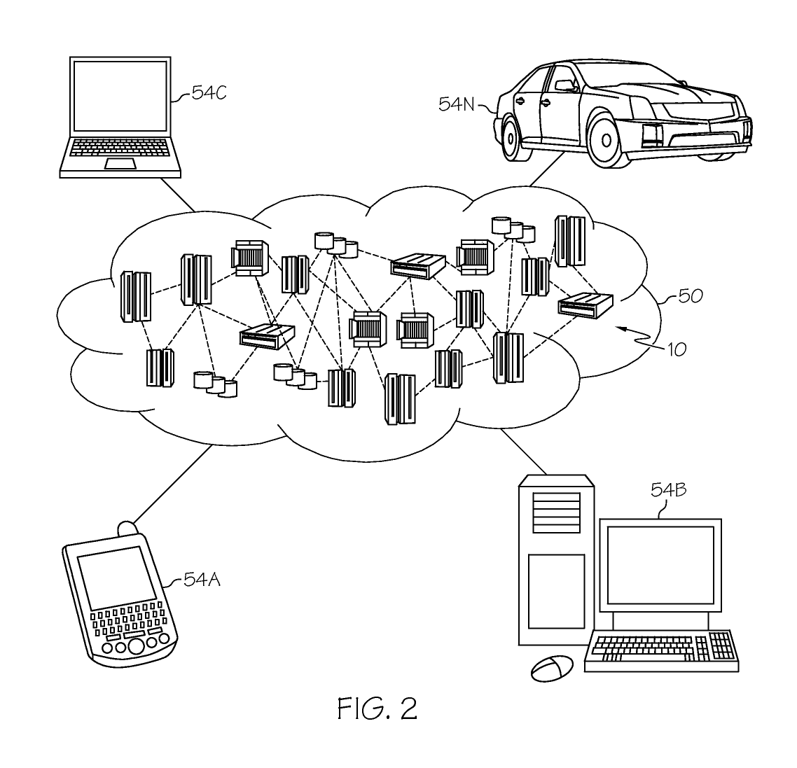

Referring now to FIG. 2, FIG. 2 depicts a cloud computing environment according to an embodiment of the present invention. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as private, community, public, or hybrid clouds as described hereinabove, or a combination thereof. This allows cloud computing environment 50 to offer infrastructure, platforms, and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

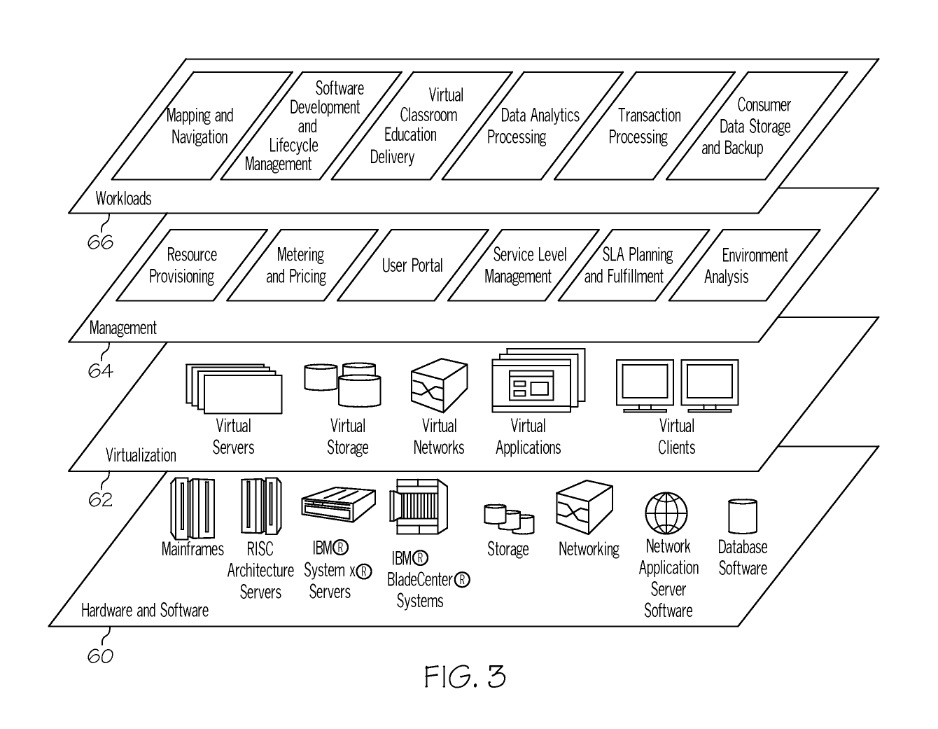

Referring now to FIG. 3, FIG. 3 depicts a set of functional abstraction layers provided by cloud computing environment 50 (FIG. 2) according to an embodiment of the present invention. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes. In one example, IBM® zSeries® systems and RISC (Reduced Instruction Set Computer) architecture based servers. In one example, IBM pSeries® systems, IBM System x® servers, IBM BladeCenter® systems, storage devices, networks, and networking components. Examples of software components include network application server software. In one example, IBM WebSphere® application server software and database software. In one example, IBM DB2® database software. (IBM, zSeries, pSeries, System x, BladeCenter, WebSphere, and DB2 are trademarks of International Business Machines Corporation registered in many jurisdictions worldwide.)

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. Consumer portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA. Further shown in management layer is environment analysis, which represents the functionality that is provided under the embodiments of the present invention.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and consumer data storage and backup. As mentioned above, all of the foregoing examples described with respect to FIG. 3 are illustrative only, and the invention is not limited to these examples.

It is understood that all functions of the present invention as described herein typically may be performed by the environment analysis functionality (of management layer 64, which can be tangibly embodied as modules of program code 42 of program/utility 40 (FIG. 1). However, this need not be the case. Rather, the functionality recited herein could be carried out/implemented and/or enabled by any of the layers 60-66 shown in FIG. 3.

It is reiterated that although this disclosure includes a detailed description on cloud computing, implementation of the teachings recited herein are not limited to a cloud computing environment. Rather, the embodiments of the present invention are intended to be implemented with any type of networked computing environment now known or later developed.

The embodiments discussed herein pertain to the suggestion/recommendation of migration to a cloud computing environment. Such an analysis could be performed by a cloud computing environment (as shown in FIGS. 1-3). However, this need not be the case.

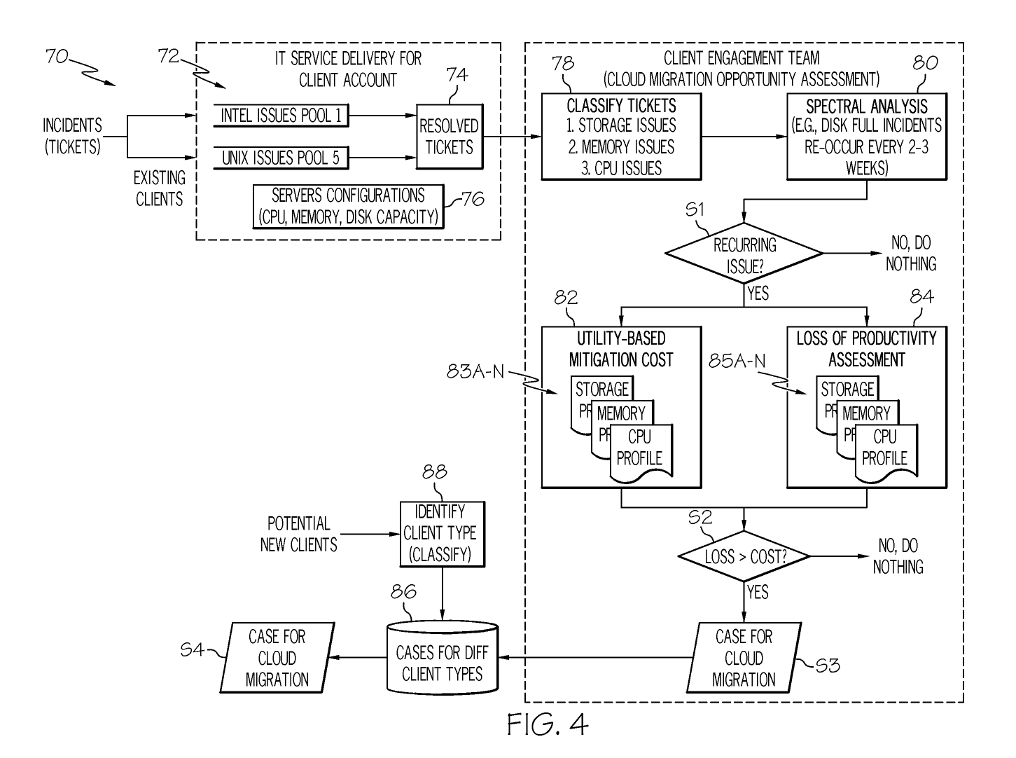

Referring now to FIG. 4, FIG. 4 shows a component/process flow diagram according to an embodiment of the present invention. In general, FIG. 4 depicts a system 70 that comprises/implements a set of components, methods, and/or steps that may be embodied as program/utility 40 stored in memory 28 of FIG. 1 (e.g., as further depicted by “environment analysis” function of management layer of FIG. 3.). Along these lines, system 70 may provide one or more of the following functions (e.g., as performed by at least one processor such as processing unit 16 of FIG. 1): analyzing historical incident data (e.g., included in one or more of a database, an outage report, a problem log, and a resolution log) of an information technology (IT) environment; classifying incident tickets in the historical incident data by incident cause type; performing a time-series analysis of the classified incident tickets; determining, from the time-series analysis, that the problem is recurring; determining, based on the historical incident data, that a problem is recurring in the IT environment; deriving a scope of the problem; mapping the scope of the problem to a set of profiles (e.g., a profile of storage characteristics, a profile of central processing unit characteristics, a profile of memory footprints, etc.); determining that the problem can be mitigated in the cloud computing infrastructure; compute a cost of mitigating the problem; computing a cost of the problem recurring; determine that the cost of the mitigating is less than the cost of the problem recurring; evaluating the cost of the mitigating using a cloud cost model and a profile in the set of profiles; and/or generating a report particular to the IT environment, the report identifying a benefit (e.g., an indication that the cost of the mitigating is less than the cost of the problem recurring) of migrating the IT environment to the cloud computing infrastructure.

More specifically, as depicted, incident tickets are received and classified into a set of pools 72 according to resource type (e.g., Intel® issues, Unix issues, etc.) The incident tickets are then addressed based on various server/system configurations 76 to yield resolved tickets 74, which are fed into a ticket classification component 78. In a typical embodiment, ticket classification component 78 may classify the tickets based upon incident type (e.g., storage issues, memory issues, CPU issues, etc.) to identify the type of problem. Thereafter, spectral analysis component 80 may perform a time series analysis to determine the problem is recurring. If not, no further action need be taken in step S1. If so, the process flows to utility-based mitigation cost component 82 and loss of productivity assessment component 84. Utility-based mitigation cost component 82 utilizes a set of profiles 83A-N (e.g., storage profiles, memory profiles, CPU profiles, etc.) of a cloud computing infrastructure to determine the cost of mitigating the problem by migrating the existing IT environment to a cloud computing infrastructure. Such cost involves not only use of various cloud computing resources (e.g., according to one or more pricing models), but also migration costs such as down time, lost opportunity costs, etc. Loss of productivity assessment component 84 may determine a cost of loss due to the problems and issues in the current IT environment (e.g., lost data, outages, etc.). It may then be determined whether the loss experienced by staying in the current IT environment is greater than the cost of mitigating the problem by migrating to the current IT environment to the cloud computing infrastructure. If not, the process may end. If so, a report comprising a plan/case for migrating the current IT environment to the cloud computing infrastructure may be generated in step S3 and sent to the target customer/client and/or stored in database 86.

Although the above-described flow pertains to existing clients/customers with a history of incident tickets, similar teachings could be applied to new clients/customers. Specifically, for each new client/customer, a client type is identified by client identification component 88. Once the client type has been identified, reports/cases previously made for similar client types may be identified from database 86 and used to generate a report/case for the new client in step S4.

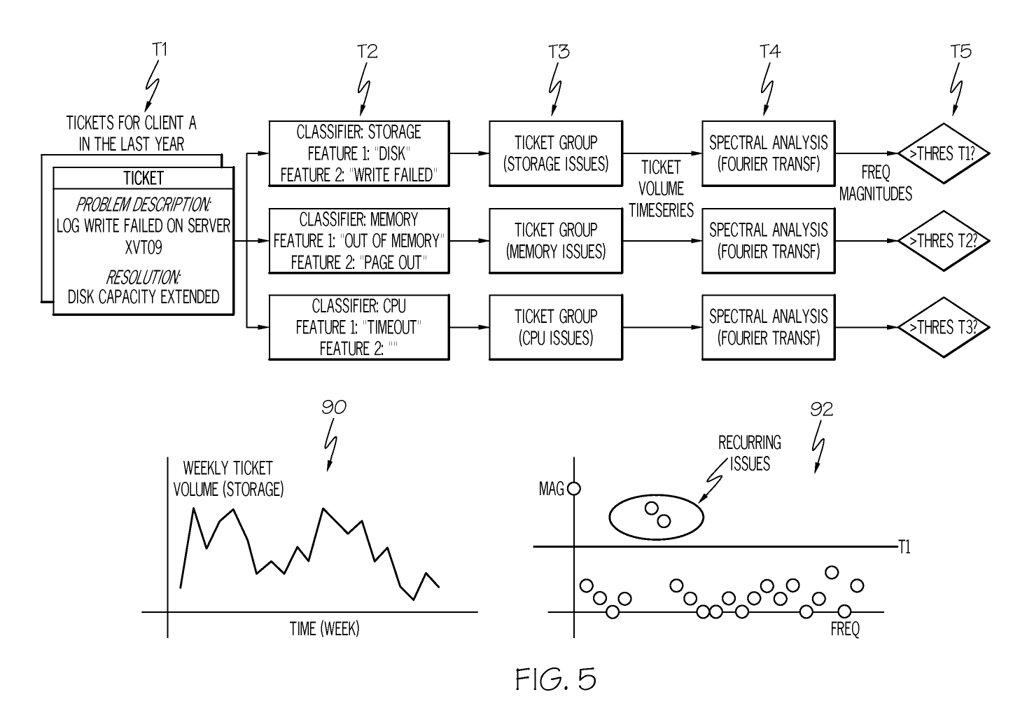

Referring now to FIG. 5, FIG. 5 shows another component/process flow diagram according to an embodiment of the present invention. The process shown in FIG. 5 is involved with classifying incident tickets and performing the time-series analysis (e.g., via ticket classification component 78 and spectral analysis component 80 of FIG. 4). As shown in step T1, resolved incident tickets are received (e.g., comprising a problem description and a resolution). In step T2, the resolved tickets may be classified by type (e.g., storage issue, memory issue, CPU issue), and/or sub-type. Once classified, the tickets may be grouped by type in step T3, and a spectral analysis can be performed on each group in step T4 to determine a frequency of recurrence of the underlying problems for each group. Then, in step T5, it may be determined whether the frequency of recurrence is greater than some predetermined threshold(s). If so, the above-described cost-benefit analysis can be performed. These concepts are further illustrated in graphs 90 and 92. Specifically, graph 90 depicts ticket volume versus time (e.g., week). Graph 92 shows the data points for graph 90 with a threshold applied. As can be seen, a grouping of data points above threshold T1 may indicate that a particular problem is a recurring issue and may need to be addressed via migration.

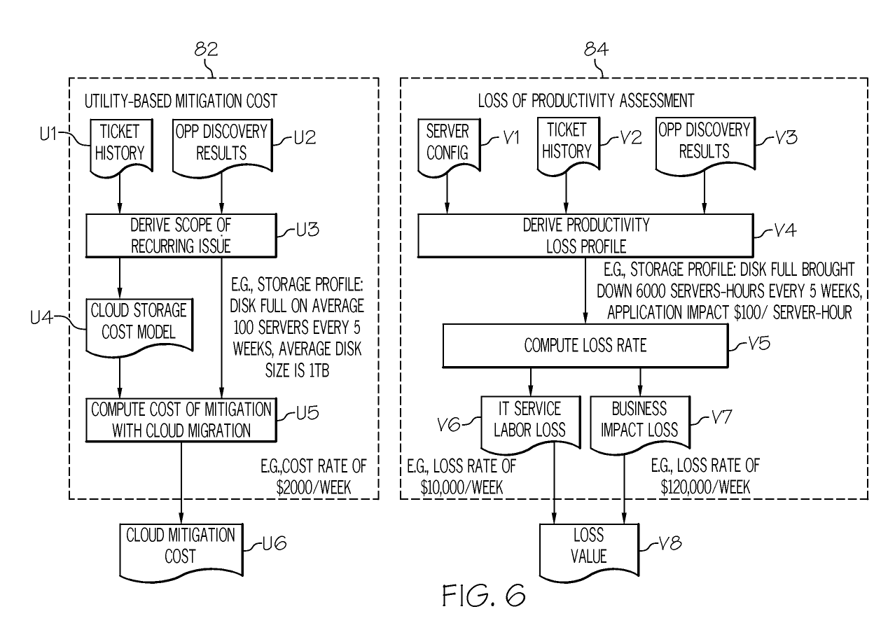

Referring now to FIG. 6, FIG. 6 shows another component/process flow diagram according to an embodiment of the present invention. The process involved with the functions of utility-based migration cost component 82 and loss of productivity assessment component 84 are shown in greater detail in FIG. 6. Referring first to utility-base mitigation cost component 82, in step U1, ticket history is received, and in step U2, operational discovery results are received. These items may be used to determine a scope of the recurring issue in step U3. In step U4 (assuming the recurring issue is a storage problem), a cost/pricing model of a cloud-based solution is determined. In step U5, a cost of mitigating the problem by migrating to a cloud-based storage solution may be determined. The two cost computations (from steps U4 and U5) may then used to compute a total mitigation cost in step U6.

Referring now to loss of productivity assessment component 84, the process may begin in steps V1-V3 with a server configuration, a ticket history and operational discovery results being received, respectively. In step V4, these items may be utilized to derive a productivity loss profile (e.g., stating the impact and extent of loss due to the problem). Based on the profile determined in step V4, a loss rate may be computed in step V5. Then, in steps V6 and V7 (respectively), IT service labor loss and a business impact loss can be computed. These losses may then be used to compute a total loss value due to the existing IT environment (or the problems therewith) in step V8. As mentioned above, the loss computed in step V8 may be compared to the total mitigation costs computed in step U6 to determine whether a migration to cloud computing infrastructure is merited.

While shown and described herein as an IT environment migration recommendation solution, it is understood that the invention further provides various alternative embodiments. For example, in one embodiment, the invention provides a computer-readable/useable medium that includes computer program code to enable a computer infrastructure to provide IT migration recommendation functionality as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide IT environment migration recommendation functionality. In this case, the service provider can create, maintain, support, etc., a computer infrastructure, such as computer system 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a method for IT environment migration recommendation. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A method for suggesting migration to a cloud computing infrastructure, the method comprising the steps of:
at least one processor analyzing historical incident data of an information technology (IT) environment;
the at least one processor determining, based on the historical incident data, that a problem is recurring in the IT environment;
the at least one processor determining that the problem can be mitigated in the cloud computing infrastructure; and
the at least one processor generating a report particular to the IT environment, the report identifying a benefit of migrating the IT environment to the cloud computing infrastructure.

2. The method of claim 1, wherein the historical incident data is included in one or more of a database, an outage report, a problem log, and a resolution log.

3. The method of claim 1, wherein the step of determining that the problem is recurring in the IT environment comprises:
the at least one processor classifying incident tickets in the historical incident data by incident cause type;
the at least one processor performing a time-series analysis of the classified incident tickets; and
the at least one processor determining, from the time-series analysis, that the problem is recurring.

4. The method of claim 1, further comprising the steps of, before the generating:
the at least one processor computing a cost of mitigating the problem; and
the at least one processor computing a cost of the problem recurring.

5. The method of claim 4, wherein the step of determining that the problem can be mitigated in the cloud computing infrastructure comprises determining that the cost of the mitigating is less than the cost of the problem recurring.

6. The method of claim 4, wherein the benefit comprises an indication that the cost of the mitigating is less than the cost of the problem recurring.

7. The method of claim 4, wherein the step of computing of the cost of the mitigating comprises:
the at least one processor deriving a scope of the problem;
the at least one processor mapping the scope of the problem to a set of profiles; and
the at least one processor evaluating the cost of the mitigating using a cloud cost model and a profile in the set of profiles.

8. The method of claim 7, wherein the set of profiles include one or more of:
a profile of storage characteristics;
a profile of central processing unit characteristics; and
a profile of memory footprints.

9. A system for suggesting migration to a cloud computing infrastructure, the system comprising:
a bus;
a computer-readable storage device coupled to the bus;
a processor coupled to the bus;
program instructions, stored on the computer-readable storage device for execution by the processor, to analyze historical incident data of an information technology (IT) environment;
program instructions, stored on the computer-readable storage device for execution by the processor, to determine, based on the historical incident data, that a problem is recurring in the IT environment;
program instructions, stored on the computer-readable storage device for execution by the processor, to determine that the problem can be mitigated in the cloud computing infrastructure; and
program instructions, stored on the computer-readable storage device for execution by the processor, to generate a report particular to the IT environment, the report identifying a benefit of migrating the IT environment to the cloud computing infrastructure.

10. The system of claim 9, wherein the historical incident data is included in one or more of a database, an outage report, a problem log, and a resolution log.

11. The system of claim 9, wherein the program instructions to determine that the problem is recurring in the IT environment comprise:
program instructions, stored on the computer-readable storage device for execution by the processor, to classify incident tickets in the historical incident data by incident cause type;
program instructions, stored on the computer-readable storage device for execution by the processor, to perform a time-series analysis of the classified incident tickets; and
program instructions, stored on the computer-readable storage device for execution by the processor, to determine, from the time-series analysis, that the problem is recurring.

12. The system of claim 9, further comprising:
program instructions, stored on the computer-readable storage device for execution by the processor, to compute a cost of mitigating the problem before generating the report; and
program instructions, stored on the computer-readable storage device for execution by the processor, to compute a cost of the problem recurring before generating the report.

13. The system of claim 12, wherein the program instructions to determine that the problem can be mitigated in the cloud computing infrastructure comprise:
program instructions, stored on the computer-readable storage device for execution by the processor, to determine that the cost of the mitigating is less than the cost of the problem recurring.

14. The system of claim 13, wherein the benefit comprises an indication that the cost of the mitigating is less than the cost of the problem recurring.

15. The system of claim 13, wherein the program instructions to compute the cost of the mitigating comprise:
program instructions, stored on the computer-readable storage device for execution by the processor, to derive a scope of the problem;
program instructions, stored on the computer-readable storage device for execution by the processor, to map the scope of the problem to a set of profiles; and
program instructions, stored on the computer-readable storage device for execution by the processor, to evaluate the cost of the mitigating using a cloud cost model and a profile in the set of profiles.

16. The system of claim 15, wherein the set of profiles include one or more of:
a profile of storage characteristics;
a profile of central processing unit characteristics; and
a profile of memory footprints.

17. A computer program product for suggesting migration to a cloud computing infrastructure, the computer program product comprising:
a computer-readable storage device;
program instructions, stored on the computer-readable storage device, to analyze historical incident data of an information technology (IT) environment;
program instructions, stored on the computer-readable storage device, to determine, based on the historical incident data, that a problem is recurring in the IT environment;
program instructions, stored on the computer-readable storage device, to determine that the problem can be mitigated in the cloud computing infrastructure; and
program instructions, stored on the computer-readable storage device, to generate a report particular to the IT environment, the report identifying a benefit of migrating the IT environment to the cloud computing infrastructure.

18. The computer program product of claim 17, wherein the historical incident data is included in one or more of a database, an outage report, a problem log, and a resolution log.

19. The computer program product of claim 17, wherein the program instructions to determine that the problem is recurring in the IT environment comprise:
program instructions, stored on the computer-readable storage device, to classify incident tickets in the historical incident data by incident cause type;
program instructions, stored on the computer-readable storage device, to perform a time-series analysis of the classified incident tickets; and
program instructions, stored on the computer-readable storage device, to determine, from the time-series analysis, that the problem is recurring.

20. The computer program product of claim 17, further comprising:
program instructions, stored on the computer-readable storage device, to compute a cost of mitigating the problem before generating the report; and
program instructions, stored on the computer-readable storage device, to compute a cost of the problem recurring before generating the report.

21. The computer program product of claim 20, wherein the program instructions to determine that the problem can be mitigated in the IT environment to the cloud computing infrastructure comprise:
program instructions, stored on the computer-readable storage device, to determine that the cost of the mitigating is less than the cost of the problem recurring.

22. The computer program product of claim 21, wherein the benefit comprises an indication that the cost of the mitigating is less than the cost of the problem recurring.

23. The computer program product of claim 21, wherein the program instructions to compute the cost of the mitigating comprise:
program instructions, stored on the computer-readable storage device, to derive a scope of the problem;
program instructions, stored on the computer-readable storage device, to map the scope of the problem to a set of profiles; and
program instructions, stored on the computer-readable storage device, to evaluate the cost of the mitigating using a cloud cost model and a profile in the set of profiles

24. The computer program product of claim 23, wherein the set of profiles include one or more of:
a profile of storage characteristics;
a profile of central processing unit characteristics; and
a profile of memory footprints.

25. A method for deploying a system for suggesting migration to a cloud computing infrastructure, comprising:
a computer system providing a computer infrastructure being operable to:
analyze historical incident data of an information technology (IT) environment;
determine, based on the historical incident data, that a problem is recurring in the IT environment;
determine that the problem can be mitigated in the cloud computing infrastructure; and
generate a report particular to the IT environment, the report identifying a benefit of migrating the IT environment to the cloud computing infrastructure.
